(19) United States
(12) Patent Application Publication
(10) Pub. No.: US 2012/0112666 A1
(43) Pub. Date: May 10, 2012

(54) ELECTRICAL OUTLET ACTIVATION AND DEACTIVATION SYSTEM

(75) Inventor: Richard G. Bennette, Boerne, TX (US)

(73) Assignee: CREATIVE INDUSTRIES, LLC, Boerne, TX (US)

(21) Appl. No.: 12/939,581

(22) Filed: Nov. 4, 2010

(51) Int. Cl. H05B 41/36; H02J 9/00; H01H 35/00

(52) U.S. Cl. 315/307; 307/116; 307/66

(57) ABSTRACT

An electrical outlet activation and deactivation system includes a controller coupled to a live power source comprising a switch and an RF signal receiver. A remote environmental sensor comprises a motion sensor, a photo cell, and an RF signal transmitter. The motion sensor, detecting a motion, sends a first condition signal coupling the live power source to the electrical outlet or device. The photo cell, detecting a daylight condition, prevents the sending of the first condition signal. A timer uncouples the live power source after a predetermined time has elapsed since the motion sensor last detected the motion. A regulator couples and uncouples the live power source to the electrical outlet or device independent of the sensor. The controller can include an electrical plug removably connectable to the live power source through an electrical outlet, or alternatively, can be permanently coupled to the live power source through a hardwire connection.

### FIELD OF THE INVENTION

The present invention generally relates to controlling electrical devices. More particularly, the present invention relates to an electrical outlet activation and deactivation system which includes a controller and a remote environmental sensor.

### BACKGROUND OF THE INVENTION

Landscape lighting, garden lighting, or outside lighting generally refers to the use of outside illumination to illuminate various landscape and architectural structures at night. During human history, outside structures and areas have been illuminated by campfires and torches, then later gas or liquid powered lamps, and now currently with electricity-based methods such as light bulbs and neon lamps. For as long as humans have been around, we have used illumination methods to brighten the night.

Night-time illumination can serve several purposes. First, illumination can be aesthetically pleasing. Many homes, buildings, or structures use illumination at night even when people are not inside the structures. People who pass by can appreciate the aesthetic appeal of the various structures and the various ways light can be cast upon the structures. Illumination can also be directed towards safety, as it is hard to see at night. Illumination can help keep criminals away by exposing any attempted crime or wrongdoing. The use of exterior or interior lighting can ward of would-be intruders, as intruders are less likely to commit crimes in well lighted areas. Also, lights can indicate the presence of people, which intruders also try to avoid. Illumination can also help one safely traverse a certain area. For instance, at night it is easy to trip or lose one's balance on uneven and unexpected changes of the walking surface. Landscape lighting or interior lighting can illuminate various walkways and make them safe for use.

In today's energy conscious world, it is always wise and desired to conserve and limit the use of energy such that it doesn't place and undue burden on our environment and resources. However, the need to safely light various areas remains. Certain areas which may require lighting may only need to do so when a passerby wants to traverse a remote walkway or area. It is uneconomical to constantly illuminate certain areas and walkways that are infrequently used. Also, this need to illuminate a certain area may be required when a traditional power line is unavailable, such as during a power outage.

Current motion sensing solar path lights are stand-alone units that have rechargeable batteries. These path lights cannot be attached to an existing power line/input electrical AC voltage or to an auxiliary solar panel. These path lights cannot store energy from an external power source to be later used if needed. These path lights cannot serve as traditional path/security lighting and cannot be selectively set to extend the operating time beyond that of the external power supply.

Furthermore, current motion sensing solar path lights are not easily connectable to an existing electrical outlet, whether that outlet is located inside or outside. Furthermore, there is not an easy way to configure traditional lighting to function as motion sensing lighting with special theft deterrent features. For instance, there is not a sensor which can be remotely located from a controller controlling the operation of inside or outside electrical devices which are connected to a standard electrical outlet and which also has a programmable controller controlling predetermined or random operation such that it mimics/simulates the appearance of human presence.

Many standard motion sensors have become predictable in that thieves have been trained to ignore their activation. A thief can quickly learn that a light turning on was not the action of a resident, but rather a motion sensor. Unless a neighbor notices the light turning on and then sees the thief, the motion sensor and activated light do little to deter a thief from committing a crime.

Accordingly, there is a need for an easy way to activate and deactivate various electrical devices. More specifically, there is a need for a remote sensor associated with a controller, where the controller can be easily connected to various electrical devices through an electrical outlet. Furthermore, there is a need to create a random or scheduled activation and deactivation such that thieves are foiled. The present invention fulfills these needs and provides other related advantages.

### SUMMARY OF THE INVENTION

The electrical outlet activation and deactivation system of the present invention includes a controller coupled to a live power source. The controller includes an RF signal receiver. A remote environmental sensor includes an RF signal transmitter. The controller, upon receiving a first condition signal from the sensor, couples the live power source to an electrical outlet or device. Additionally, the controller, upon receiving a second condition signal, uncouples the live power source from the electrical outlet or device. A switch can be associated with the controller for coupling and uncoupling the live power source to the electrical outlet or device.

The sensor can include a motion sensor. The motion sensor, on detecting a motion, sends the first condition signal to the controller. The signal is sent from the RF signal transmitter to the RF signal receiver. Furthermore, the motion sensor can include a passive infrared motion sensor.

A timer can be associated with the controller. The timer sends the second signal condition to uncouple the live power source from the electrical outlet or device after a predetermined time has elapsed since the motion sensor last detected the motion.

The controller can include a regulator which can also send the first condition signal coupling the live power source and a second condition signal uncoupling the live power source. The regulator couples and uncouples the live power source to the electrical outlet or device independent of the sensor. The regulator can be programmed to send the signals at predetermined and scheduled times, or to operate randomly.

The regulator can be programmable, sending of the first condition signal and second condition signal in a predetermined schedule. This allows a user to set a predetermined schedule that mimics the activity of a resident who is home. This simulates the appearance of a resident to a would-be thief and therefore acts as a deterrence. Alternatively, the regulator can be random, sending the first condition signal and second condition signal in a random schedule. This is an easy option for a user to select rather than creating their own predetermined schedule.

The controller, upon receiving a first condition signal from the sensor, couples the live power source to an electrical outlet or device until it receives a second condition signal from the timer, regardless of whether it has received a second condition signal sent by the regulator. This allows motion to be detected and a device activated overriding any unintended turning off of a device due to the predetermined or random schedule.

The sensor can include a photo cell which. The photo cell, upon detecting a daylight condition, prevents the sending of the first condition signal to the controller.

The sensor can include a solar cell and a rechargeable battery. This allows ease of placement of the sensor in an outside landscape. The sensor can include a ground stake for further ease of installation in the outside landscape. Alternatively, the sensor can be permanently coupled to the live power source through a hardwire connection.

The electrical outlet can power many types of devices, whether those devices are indoor or outdoor. In one exemplary embodiment, the device can include an indoor or outdoor lighting system. Furthermore, the lighting system can include a light emitting diode or a plurality of light emitting diodes.

The controller can be packaged within a plug-in structure for ease of installation into an existing electrical outlet. In an exemplary embodiment, the controller includes an electrical plug removably connectable to the live power source through an electrical outlet. Alternatively, the controller can be permanently coupled to the live power source through a hardwire connection.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an outside perspective view of an exemplary electrical outlet activation and deactivation system embodying the present invention;

FIG. 2 is an inside perspective view of another exemplary electrical outlet activation and deactivation system embodying the present invention;

FIG. 3 is a perspective view of another exemplary electrical outlet activation and deactivation system embodying the present invention;

FIG. 4 is a front perspective view of an exemplary embodiment of a controller of the present invention;

FIG. 5 is a rear perspective view of the structure of FIG. 4;

FIG. 6 is a schematic view of the controller of FIGS. 4 and 5; and

FIG. 7 is a schematic view of a remote environmental sensor embodying the present invention.

### DETAILED DESCRIPTION OF THE PREFERRED EMBODIMENTS

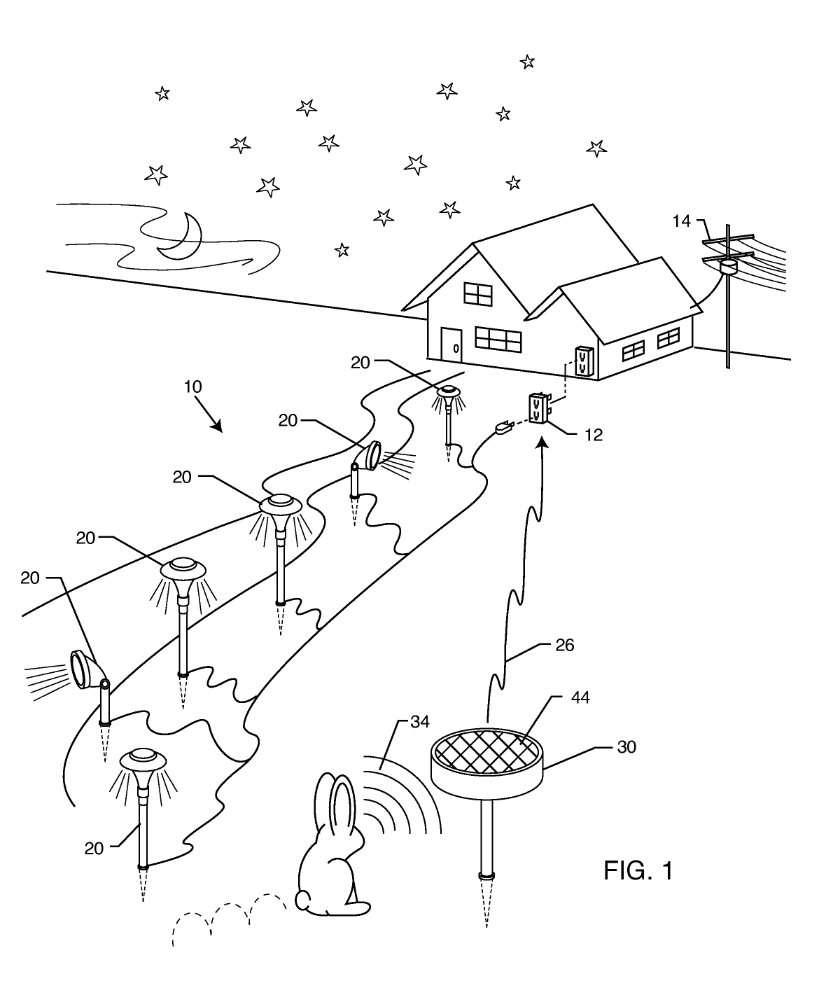

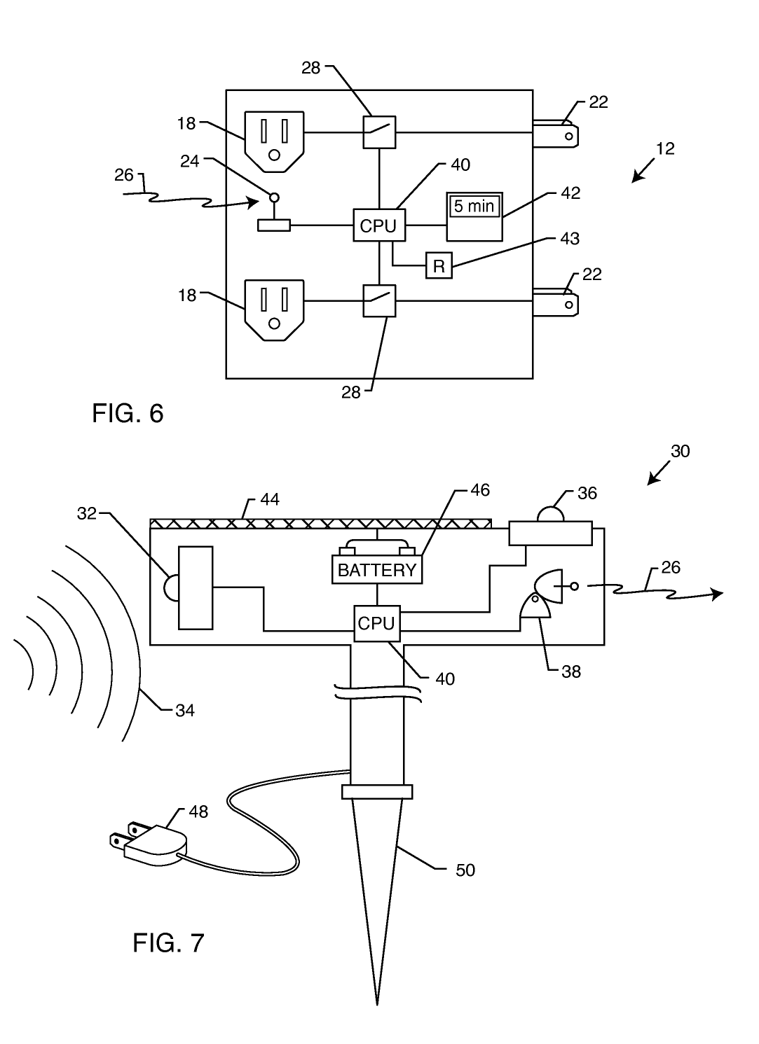

As shown in the drawings for purposes of illustration, the present invention for an electrical outlet activation and deactivation system is referred to generally by the reference number 10. FIG. 1 is an outside perspective view of an exemplary electrical outlet activation and deactivation system 10 embodying the present invention. The electrical outlet activation and deactivation system 10 includes a controller 12 coupled to a live power source 14. FIGS. 4 and 5 are perspective views of an exemplary embodiment of a controller 12. FIG. 6 is a schematic view of the embodiment in FIGS. 4 and 5.

In an exemplary embodiment, the controller 12 has a case 16 designed to be pluggable into a standard electrical outlet that is commonly found inside and outside buildings and which is already connected to a live power source 14. The controller 12 can include an electrical outlet 18. The electrical outlet 18 is similar to the commonly used female-sided electrical outlets. The electrical outlet 18 can then be connected to various devices 20. The controller 12 can also include the male-sided plug 22. The plug 22 is then connected into a standard electrical outlet. In another embodiment, the controller 12 can be hardwired into a buildings structure such that it is disposed between the live power source 14 and the electrical outlet 18. In this variation the electrical outlet 18 and a standard electrical outlet are on in the same.

The controller 12 includes an RF signal receiver 24. The receiver 24 can then receive an RF signal 26 sent by a remote sensor or the like. The controller 12 can also include a switch or a plurality of switches 28. The switch 28 is a controllable electrical connection between the plug 22 and the outlet 18. Opening and closing the switch 28 then either couples or uncouples the device 20 to the live power source 14.

FIG. 7 is a schematic view of a remote environmental sensor 30 embodying the present invention. In an exemplary embodiment the sensor 30 can include a motion sensor 32. The motion sensor 32 can detect a motion 34. Motion 34 can be caused by a variety of reasons, such as people walking in close proximity, intruders, or even wildlife. The motion sensor 32 can be a multitude of types and this disclosure is not intended to limit it to the precise form described herein. For instance, the motion sensor 32 can be a passive infrared motion sensor 32.

The sensor 30 can also include a photo cell 36. The photo cell 36 is designed to detect whether there is too much or too little ambient light. Such a condition is when it is daylight and activating the device 20 would be wasteful. The photo cell 36 can be a multitude of types and this disclosure is not intended to limit it to the precise form described herein.

In some embodiments, it may be desired to connect a video camera that is associated with the sensor 32. This would provide 24/7 monitoring capability. Accordingly, in an exemplary embodiment the photo cell 36 can include an on/off switch or a cover such that the sensor 32 can work in a daylight condition if desired.

The sensor 30 can also include an RF signal transmitter 38. The transmitter 38 can send the RF signal 26 from the sensor 30 to the receiver 24 of the controller 12. This is a method of communicating the conditions the sensor 30 is detecting to then control the switch 28 such that various devices 20 are either coupled or uncoupled to the live power source 14. The RF signal transmitter can be a multitude of types and this disclosure is not intended to limit it to the precise form described herein.

Both the sensor 30 and the controller 12 have some form of a central processing unit 40. The CPU 40 can be simply central processing logic in the form of simplistic electronic circuitry or the CPU could be more sophisticated programmable chips. What is necessary is that the switch 28 reacts appropriately when it receives various signals 26 from the sensor 30.

Information provided to the controller 12 can make the switch 28 behave differently depending on what the condition is. For instance, the controller 12 upon receiving a first condition signal from the sensor 30, can couple the live power source 14 to an electrical outlet 18 or device 20. The first signal condition can be when the motion detector 32 detects a motion 34. If the photo cell 36 registers that it is a daylight condition, the motion 34 detected will not trigger a signal 26 to be transmitted. If the photo cell 36 registers that it is not a daylight condition and is dark outside, the motion 34 detected will trigger a signal 26 to be transmitted. Once motion 34 has stopped, the sensor 30 can stop transmitting the first condition signal. Alternatively, a second condition signal can be sent by the controller 12 and/or a timer 42. Either method uncouples the live power source 14 from the electrical outlet 18 or device 20.

A timer 42 can be associated with the controller 12, or alternatively with the sensor 30. The timer 42 sends a second signal condition to uncouple the live power source 14 from the electrical outlet 18 or device 20 after a predetermined time has elapsed since the motion sensor 32 last detected the motion. This allows the device 20 to remain on for a predetermined time, and then turned off after such predetermined time has elapsed.

A regulator 43 can be associated with the controller 12. The regulator 43 can send the first condition signal coupling the live power source to the electrical outlet 18 or device 20. The regulator can also send the second condition signal uncoupling the live power source to the electrical outlet 18 or device 20. The regulator 43 works independent of the sensor 30. The regulator 43 can be part of the CPU 40, or a separate unit 43 that is associated with the CPU 40 and switches 28. The regulator 43 can be programmed to send the signals at predetermined/scheduled times, or to operate randomly.

The regulator 43 is a critical part of the electrical outlet activation and deactivation system 10 that is used to give the appearance that someone is home, when no one actually is. Many times thieves and hoodlums are knowledgeable of the operation of standard motion sensors and have learned to ignore their activation. When a thief moves in the presence of a motion sensor, the thief knows the activation was a direct result of their movement and not a result of a resident. When the controller 12 randomly, or by a schedule, activates the electrical outlet 18 or device 20 in the absence of a motion 34, the thief will assume it was the result of a resident. The regulator 43 can be chosen to operate in a random fashion, where internal logic or CPU 40 would decide when the live power source 14 was coupled or uncoupled. Alternatively, a consumer can create their own schedule which simulates the activities of a real resident.

The regulator 43 can be programmable, sending of the first condition signal and second condition signal in a predetermined schedule. This allows a user to set a predetermined schedule that mimics the activity of a resident who is home. This simulates the appearance of a resident to a would-be thief and therefore acts as a deterrence. Alternatively, the regulator 43 can be random, sending the first condition signal and second condition signal in a random schedule. This is an easy option for a user to select rather than creating their own predetermined schedule.

The controller 12, upon receiving a first condition signal from the sensor 32, couples the live power source 14 to an electrical outlet 18 or device 20 until it receives a second condition signal from the timer 42, regardless of whether it has received a second condition signal sent by the regulator 43. This allows motion 34 to be detected and a device 20 activated overriding any unintended turning off of a device 20 due to the predetermined or random schedule. This functionality sets the sensor 32 as the primary control of the switch 28 and overrides any control by the regulator 43 at least until the predetermined time of the timer 42 has elapsed.

The sensor 30 can include a solar cell 44 and a rechargeable battery 46. This allows ease of placement of the sensor 30 in an outside landscape, as it does not have to be physically tied to a power cord 48. Alternatively, the sensor 30 can use a hardwire connection, such as a power cord 48, rather than collect, store, and use solar energy. The sensor 30 can also include a ground stake 50 for further ease of installation in the outside landscape.

FIG. 1 shows outside perspective view of an exemplary electrical outlet activation and deactivation system 10. A plurality of devices 20 are connected to the controller 12. The controller 12 is installed to an exterior standard type electrical outlet. The devices 20 can be a multitude of types, however is shown here as outside landscape lighting. When a motion 34 is detected, the lights can be activated to illuminate a pathway. The lights then help to illuminate walkways for the residents of the house or building, or to scare away intruders and wildlife.

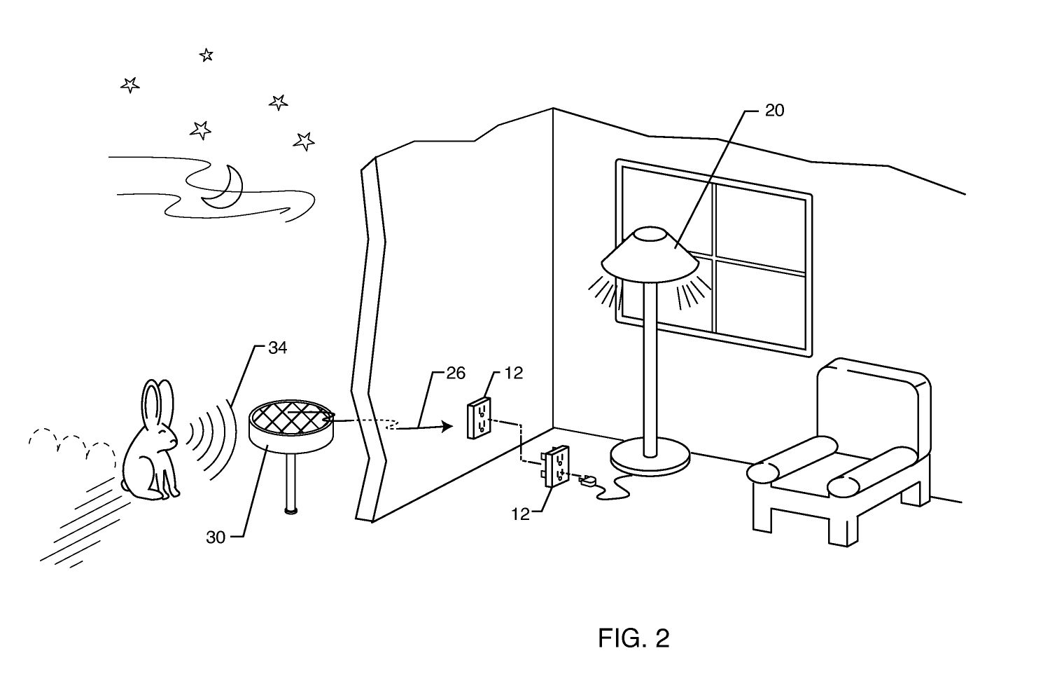

FIG. 2 is an inside perspective view of an exemplary electrical outlet activation and deactivation system 10 embodying the present invention. A device 20 is connected to the controller 12. The controller 12 is installed inside of a building or house and connected to a standard type electrical outlet. When a motion 34 is detected, a signal 26 can be sent to the controller 12 located inside, rather than just being located outside.

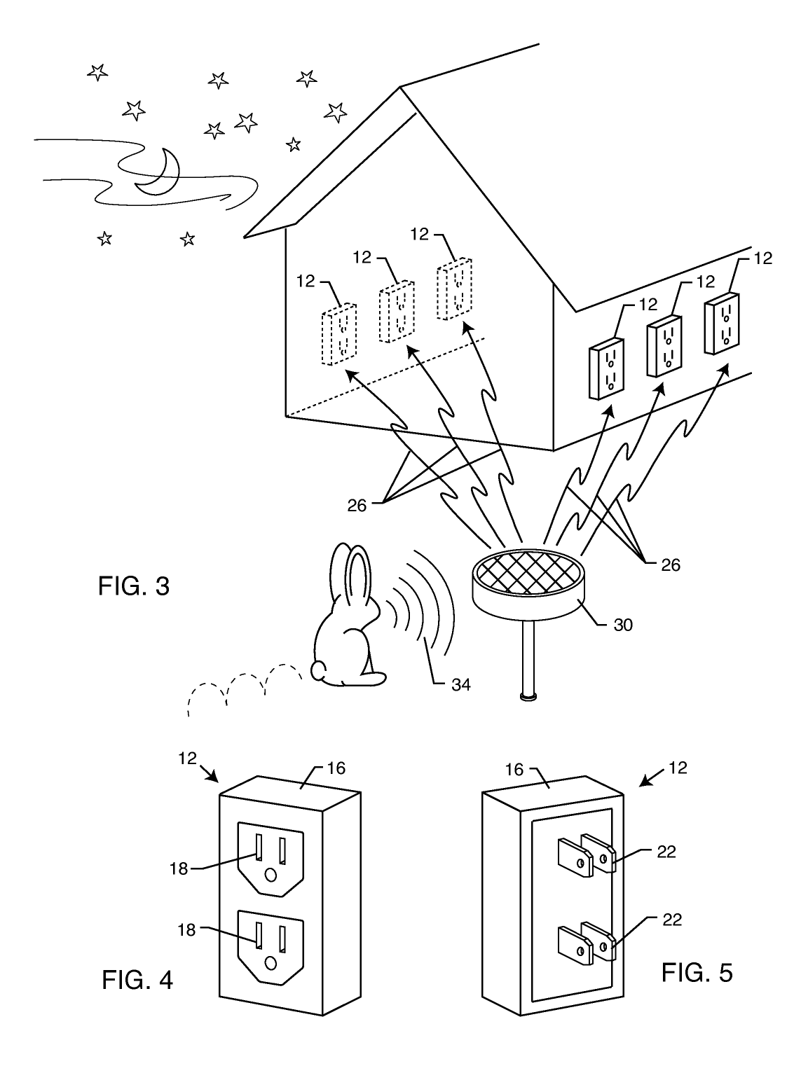

FIG. 3 is a perspective view of another electrical outlet activation and deactivation system 10 embodying the present invention. FIG. 3 shows that a multitude of controllers 12 can be utilized responding to a single sensor 30. Also, the controllers 12 can be located inside and outside at the same time.

The advantage of the electrical outlet activation and deactivation system 10 is in its simplicity and ease of use. For an existing landscape lighting system to be converted to a “smart” landscape lighting system involves the purchase of a single sensor 30 and either one or more controllers 12. The sensor 30 is located in the landscape and then the controller 12 is plugged in between the existing landscape lighting and the various devices 20. Installation of the system 10 can literally be accomplished in under a minute.

Although several embodiments have been described in detail for purposes of illustration, various modifications may be made to each without departing from the scope and spirit of the invention. Accordingly, the invention is not to be limited, except as by the appended claims.

What is claimed is:

1. An electrical outlet activation and deactivation system, comprising:
a controller coupled to a live power source including an RF signal receiver;
a remote environmental sensor including an RF signal transmitter;
wherein the controller, upon receiving a first condition signal from the sensor, couples the live power source to an electrical outlet or device, and wherein the controller, upon receiving a second condition signal, uncouples the live power source from the electrical outlet or device; and
a regulator associated with the controller for sending the first condition signal and second condition signal, such that the live power source and electrical outlet or device are coupled and uncoupled independent of the sensor.

2. The system of claim 1, where the sensor comprises a motion sensor which, on detecting a motion, sends the first condition signal to the controller.

3. The system of claim 2, where the motion sensor comprises a passive infrared motion sensor.

4. The system of claim 2, including a timer associated with the controller, where the timer sends the second signal condition to uncouple the live power source from the electrical outlet or device after a predetermined time has elapsed since the motion sensor last detected the motion.

5. The system of either of claim 1 or 2, where the sensor comprises a photo cell which, upon detecting a daylight condition, prevents the sending of the first condition signal to the controller.

6. The system of claim 1, where the sensor comprises a solar cell and a rechargeable battery.

7. The system of claim 1, where the sensor is permanently coupled to the live power source through a hardwire connection.

8. The system of either of claim 1 or 2, where the device comprises an indoor or outdoor lighting system.

9. The system of claim 8, where the lighting system comprises a light emitting diode.

10. The system of claim 1, where the controller comprises an electrical plug removably connectable to the live power source through an electrical outlet.

11. The system of claim 1, where the controller is permanently coupled to the live power source through a hardwire connection.

12. The system of either of claim 10 or 11, including a switch associated with the controller for coupling and uncoupling the live power source to the electrical outlet or device.

13. The device of claim 4, wherein the regulator is programmable, sending of the first condition signal and second condition signal in a predetermined schedule.

14. The device of claim 4, wherein the regulator is random, sending the first condition signal and second condition signal in a random schedule.

15. The device of claim 13 or 14, wherein the controller, upon receiving a first condition signal from the sensor, couples the live power source to an electrical outlet or device until it receives a second condition signal from the timer, regardless of whether it has received a second condition signal from the regulator.

16. An electrical outlet activation and deactivation system, comprising:
a controller coupled to a live power source comprising a switch and an RF signal receiver, where the switch couples and uncouples the live power source to an electrical outlet or device;
a remote environmental sensor comprising a motion sensor, a photo cell, and an RF signal transmitter;
wherein the motion sensor which, on detecting a motion, sends a first condition signal to the controller coupling the live power source to the electrical outlet or device, and where the photo cell which, upon detecting a daylight condition, prevents the sending of the first condition signal to the controller; and
a regulator associated with the controller for sending the first condition signal and a second condition signal which uncouples the live power source from the electrical outlet or device, such that the live power source and electrical outlet or device are coupled and uncoupled independent of the sensor.

17. The system of claim 16, including a timer associated with the controller, where the timer sends a second signal condition to uncouple the live power source from the electrical outlet or device after a predetermined time has elapsed since the motion sensor last detected the motion.

18. The system of claim 16, where the controller comprises an electrical plug removably connectable to the live power source through an electrical outlet.

19. The system of claim 16, where the controller is permanently coupled to the live power source through a hardwire connection.

20. The system of claim 16, where the sensor comprises a solar cell and a rechargeable battery.

21. The system of claim 16, where the sensor is permanently coupled to the live power source through a hardwire connection.

22. The system of claim 16, where the device comprises an indoor or outdoor lighting system.

23. The system of claim 22, where the lighting system comprises a light emitting diode.

24. The device of claim 17, wherein the regulator is programmable, sending of the first condition signal and second condition signal in a predetermined schedule.

25. The device of claim 17, wherein the regulator is random, sending the first condition signal and second condition signal in a random schedule.

26. The device of claim 24 or 25, wherein the controller, upon receiving a first condition signal from the sensor, couples the live power source to an electrical outlet or device until it receives a second condition signal from the timer, regardless of whether it has received a second condition signal from the regulator.

27. An electrical outlet activation and deactivation system, comprising:
a controller coupled to a live power source comprising a switch and an RF signal receiver, where the switch couples and uncouples the live power source to an electrical outlet or device;
a remote environmental sensor comprising a motion sensor, a photo cell, and an RF signal transmitter;
wherein the motion sensor which, on detecting a motion, sends a first condition signal to the controller coupling the live power source to the electrical outlet or device, and where the photo cell which, upon detecting a daylight condition, prevents the sending of the first condition signal to the controller;
a timer associated with the controller, where the timer sends a second signal condition to uncouple the live power source from the electrical outlet or device after a predetermined time has elapsed since the motion sensor last detected the motion; and
a regulator associated with the controller for sending the first condition signal and a second condition signal which uncouples the live power source from the electrical outlet or device, such that the live power source and electrical outlet or device are coupled and uncoupled independent of the sensor;
wherein the regulator is programmable, sending of the first condition signal and second condition signal in a predetermined schedule or wherein the regulator is random, sending the first condition signal and second condition signal in a random schedule;
wherein the controller, upon receiving a first condition signal from the sensor, couples the live power source to an electrical outlet or device until it receives a second condition signal from the timer, regardless of whether it has received a second condition signal from the regulator.
